(19) United States
(12) Patent Application Publication
(10) Pub. No.: US 2006/0029033 A1
(43) Pub. Date: Feb. 9, 2006

(54) Method for forwarding traffic having a predetermined category of transmission service in a connectionless communications network

(75) Inventor: Cheng-Yin Lee, Ottawa (CA)

Correspondence Address: KRAMER & AMADO, P.C., Suite 240, 1725 Duke Street, Alexandria, VA, 22314, US

(73) Assignee: ALCATEL, Paris (FR)

(21) Appl. No.: 10/911,692

(22) Filed: Aug. 5, 2004

(51) Int. Cl. H04L 12/28

(52) U.S. Cl. 370/351

(57) ABSTRACT

A method of forwarding traffic in a connectionless communications network from a source location to a destination location. The traffic is associated with a predetermined category of transmission service. The method involves assigning a principal path to the traffic. The principal path operatively connects the source and destination locations. The principal path is determined on the basis that transmission of the traffic from the source location to the destination location does not exceed a specified maximum delay for transmission. An alternate path is also assigned to the traffic. The alternate path is selected on the basis that the alternate path does not exceed a specified maximum delay for involving the alternate path in order to forward the traffic along the alternate path in the event the principal path is unavailable for forwarding the traffic.

### FIELD OF THE INVENTION

The present invention relates generally to the field of communications networks and more particularly, to a method and apparatus for providing predetermined categories of transmission service in such networks. For instance, the present invention may be deployed in the provisioning of an end-to-end network traffic path which is compliant with a predetermined category of transmission service, commonly referred to in this art as Quality of Service (QoS), in a communications network associated with a connectionless routing protocol for which network topology information is periodically distributed to network entities thereof. By way of example, the communications network as aforesaid may be a network operating according to the Internet Protocol (IP) suite.

### BACKGROUND OF THE INVENTION

Various attempts have been made in the art of communications networks to provide techniques or mechanisms for differentiated services in connectionless routing protocols, namely for provisioning bandwidth or other resources so as to deliver message paths having defined categories or classes of transmission service. In some such techniques or mechanisms, the differentiated service in question is not deterministic in that it does not truly guarantee a desired Quality of Service. In other such instances, the particular approaches that are implemented with a view to achieving a predetermined Quality of Service do not scale well to larger network topologies. By way of example, it has been sought to provide Quality of Service functionality in IP networks by means of Integrated Services (“IntServ”) architectures, Differentiated Services (“DiffServ”) architectures or various combinations thereof (“IntServ/DiffServ”).

In typical IntServ architectures, a per-flow classification and processing of packets is provided. However, the scalability of IntServ architectures is rendered difficult in network environments such as the Internet, which potentially may involve billions of end-to-end traffic flows. The IntServ techniques may also be associated with poor routing convergence behaviour. This phenomenon will generally manifest itself where a change to a network topology has not been communicated fully throughout the network. In these circumstances, effective forwarding of traffic flows may become suspended for the period of time that the network is in a transient state, wherein some components of the network do not share a consistent view of the changed network topology with other components of the network. Once the changed network topology has been communicated to the network in its entirety, a steady state routing environment is restored and normal routing behaviour can be expected to take place. If routing is attempted while such a network is in its transient state, traffic flows may very well encounter routing loops that do not converge in a viable or effective path for the flows in question.

The length of time required to achieve restoration of steady state routing as discussed above may typically exceed 50 milliseconds, such that the expected delay requirements of real-time traffic services may not be achieved. One known solution to the problem of poor routing convergence has been that of provisioning every differentiated services traffic path or traffic segment thereof with a backup traffic path. However, this approach has been known to further hamper the scalability of typical IntServ architectures. Techniques or mechanisms that resemble those of IntServ architectures are exemplified by the Resource Reservation Protocol (“RSVP”), Multi-Protocol Label Switching (“MPLS”) and other circuit-switched resource allocation methodologies, all of which share in the various disadvantages discussed previously.

In the case of known DiffServ architectures, individual traffic flows are combined into aggregated traffic flows that collectively receive treatment at nodes or routers along the flow path of the traffic depending on an assigned per class or per service state. While eliminating reliance upon per flow state and per flow processing and thereby alleviating scalability problems to some degree, DiffServ techniques are not typically deterministic since traffic flows are managed and policed on a hop-by-hop basis. In combined IntServ/DiffServ architectures, a network formed of one or more DiffServ provisioned regions is subjected to IntServ provisioned end-to-end control. This combined approach largely inherits the same disadvantages associated with each of the IntServ or DiffServ architectures when used separately.

Based on the foregoing, it would therefore be desirable to provide a method and apparatus for the forwarding differentiated services traffic flows in connectionless packet switched communications networks while attempting to alleviate the problems of poor scalability and non-deterministic quality of service as associated with the known methods and techniques discussed previously.

### SUMMARY OF INVENTION

According to a broad aspect of the present invention, there is provided a method of forwarding traffic in a connectionless communications network from a source location to a destination location, the traffic being associated with a predetermined category of transmission service, the method comprising the steps of:
assigning a principal path to the traffic, the principal path operatively connecting the source location with the destination location, the principal path being determined on the basis that transmission of the traffic from the source location to the destination location does not exceed a specified maximum delay for transmission; and
assigning an alternate path to the traffic, the alternate path being selected on the basis that the alternate path does not exceed a specified maximum delay for invoking the alternate path in order to forward the traffic therealong in the event that the principal path is unavailable therefor.

### BRIEF DESCRIPTION OF THE DRAWINGS

By way of illustration and not of limitation, embodiments of the present invention will next be described with reference to the following drawing, in which:

FIG. 1 is a representation of a communications network in which the present invention may be deployed for forwarding traffic having a predetermined category of transmission service.

### DETAILED DESCRIPTION OF EMBODIMENTS

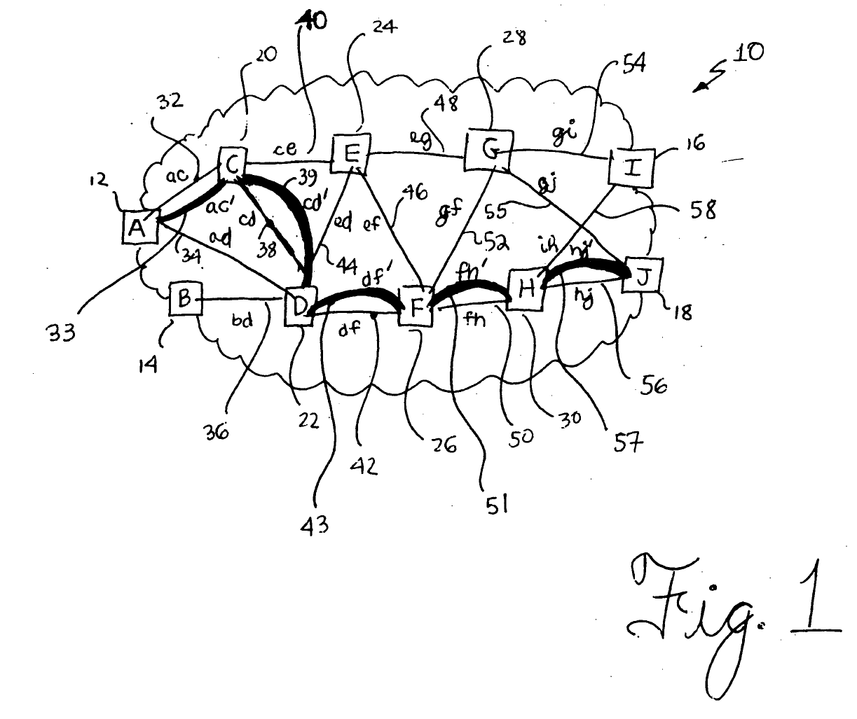

With reference to FIG. 1, there is shown an exemplary communications network 10 such as a communications network based on a connectionless packet switched protocol. By way of the example, the network 10 may operate according to the Internet Protocol (“IP”) suite. The network 10 has ingress nodes A and B, respectively denoted 12 and 14, from which traffic flows may be forwarded to egress nodes I and J thereof, denoted 16 and 18. The ingress nodes A and B may for instance be edge routers, as may also be the case for the egress nodes I and J. One or more intermediate nodes C, D, E, F, G and H, denoted respectively 20, 24, 26, 28 and 30, may be provisioned within the network 10 between any pairing selected from one of the ingress nodes A, B and from one of the egress nodes I, J. The intermediate nodes C, D, E, F, G and H may, for instance, be routers or other like network entities.

The various ingress, egress and intermediate nodes A, B, C, D, E, F, G, H, I and J of network 10 are operatively connected by means of primary path segments ac, ad, bd, cd, ce, df, ed, ef, eg, fh, gf, gi, gj, hj and ih, which are themselves respectively denoted 32, 34, 36, 38, 40, 42, 44, 46, 48, 50, 52, 54, 55, 56 and 58. In the particular architecture of network 10, a number of candidate traffic paths are therefore available for the forwarding of traffic between a given ingress node A or B and a given egress node I or J. For instance, if it is sought to forward a traffic flow from ingress node A to egress node J, a variety of paths may be available. Namely, one such candidate traffic path may be the path ac-ce-eg-gj formed of principal path segments ac, ce, eg and gj. Another such candidate traffic path may be the path ac-cd-df-fh-hj formed of principal path segments ac, cd, df, fh and hj. Other candidate traffic paths of the network 10 for forwarding a traffic flow from a given ingress node A or B to a given egress node I or J will be apparent to those skilled in this art.

The network 10 may be utilized according to the present invention in order to forward traffic which has been denoted as having a predetermined category of transmission service. For instance, such traffic may have a differentiated category of transmission service or a predetermined Quality of Service (“QoS”), as may be associated with real-time traffic. According to an embodiment of the method of the present invention, a principal path is assigned to the traffic. The principal path is determined by selecting a candidate path within the network 10 that is associated with a desired transmission delay for transmission of the traffic along the candidate path. Namely, the transmission delay of the candidate path does not exceed a specified maximum delay for transmission of the traffic from an intended source location to an intended destination location.

By way of example, if traffic having the predetermined category of transmission service cannot tolerate a specified maximum delay of transmission of 150 milliseconds, and if the traffic is intended to be forwarded from ingress node A to egress node J, two candidate traffic paths for forwarding the traffic within the network 10 may be the previously mentioned paths ac-ce-eg-gj or ac-cd-df-fh-hj. Assuming that the candidate path ac-ce-eg-gj was associated with an end-to-end transmission delay of 200 milliseconds and that the candidate path ac-cd-df-fh-hj was associated with an end-to-end transmission delay of 100 milliseconds, then the candidate path ac-cd-df-fh-hj would be selected as a principal path for transmission of the differentiated services traffic. By end-to-end transmission delay is meant the cumulative transmission delay for forwarding of the traffic along a candidate path from the intended source location to the intended destination location. Thus, the cumulative transmission delay is obtained by aggregating the transmission delays respectively associated with each of the principal path segments of a candidate path from the intended source location to the intended destination location.

Those skilled in this art will understand that it may be sufficient to select any candidate traffic path within network 10 which meets the constraint of the specified maximum transmission delay as aforesaid. By way of example, if the traffic having the predetermined category of transmission service cannot tolerate a specified maximum delay of transmission of 250 milliseconds, either of the candidate paths ac-ce-eg-gj or ac-cd-df-fh-hj will meet the maximum transmission delay constraint and either may be selected as the principal path. Alternatively, the method according to the present invention may also be utilized so as to select the candidate traffic path of the network 10 which has the lowest actual end-to-end transmission delay from the intended source location to the intended destination location. In the example just given, the candidate path ac-cd-df-fh-hj would be selected as the principal path for transmission of the differentiated services traffic since it is associated with the lowest actual end-to-end transmission delay.

In a further alternative embodiment, the selection of the principal path may also take into account the length of the path or the number of hop-to-hop segments which must be traversed between the intended source location and the intended destination location. Thus, the selection of the principal path may therefore be made on the basis of the shortest candidate path which meets the maximum delay constraint discussed previously, and this shortest path may for instance be determined on the basis of the number of hop-to-hop segments being so traversed. In a yet further alternative, a desired cost metric as known to those skilled in this art may be utilized as a further constraint in the selection of the principal path, such that the selection of the principal path will be made on the basis of the lowest cost candidate path which meets the maximum delay constraint discussed previously.

Once a principal path for transmission of the differentiated services traffic has been assigned to a differentiated services traffic flow according to any of the preceding embodiments, this assigned principal path is installed on all affected nodes of the network 10. To resume with the example discussed immediately previously, the selected candidate path ac-cd-df-fh-hj will be installed on nodes A, C, D, F, H and J of the network 10.

In addition to assigning a principal traffic path to the differentiated services traffic according to the constraint of meeting a maximum transmission delay as described above, the method of the present invention also assigns an alternate path to the differentiated services traffic in the manner next described. According to the method of the invention, the alternate path is selected on the basis that the alternate path does not exceed a specified maximum delay for invoking the alternate path in order to forward the traffic flow therealong in the event that the principal path is unavailable therefor. By way of example, it may be deemed appropriate to require a given timeliness of link or path restoration for a particular differentiated services traffic flow. For instance, it may be deemed tolerable for a particular traffic flow and network architecture that a maximum restoration delay of 50 milliseconds should apply. In such a case, this restoration delay will define the specified restoration delay for invoking the alternate path in the event the principal path becomes unavailable for forwarding the traffic. The alternate path to be assigned to the differentiated services traffic in question will therefore be selected so that the constraint associated with the restoration delay is met, in that the alternate path may be invoked or called into service to forward the traffic flow instead of the principal path within the maximum restoration delay of 50 milliseconds.

An alternate path may be comprised of a protected link for each of the principal path segments of the network 10. For instance, where the assigned principal path is the path ac-cd-df-fh-hj previously described, the protected links ac′, cd′, df′, fh′ and hj′ of network 10 may be assigned to the differentiated services traffic flow, each of these protected links respectively denoted 33, 39, 43, 51 and 57. Such protected links may be physical links, but those skilled in this art will comprehend that instead of physical links other types of constructs may be utilized to define an alternate path. For instance, the alternate path may be comprised of SONET/SDH protected paths or links, 802.3 ad aggregated links, a protected label switched path (“LSP”), a forwarding adjacency such as a Multi-Protocol Label Switching (“MPLS”) forwarding adjacency, a bypass tunnel, or a protection path such as an Asynchronous Transfer Mode (“ATM”) protection path, to name but some examples. The alternate path may also be comprised of a traffic replicated path, for instance a label switched path with packet replication. In yet a further alternative, the alternate path in question may form part of a backup routing plane, wherein the backup routing plane may be used for handling excess traffic that can be discarded or preempted by the differentiated services traffic diverted to the backup routing plane from the primary path. The object of assigning the alternate path to the differentiated services traffic is to attempt to reduce the likelihood that the traffic in question will be impacted by slow link restoration or slow routing convergence, as may transpire with some known methods of provisioning differentiated services traffic in connectionless communications networks.

According to one embodiment of the method of the present invention, an alternate path may be assigned to a principal path once the latter has been assigned to a given differentiated services traffic flow. The assignment of the alternate path may therefore be made statically or manually following the selection or computation of the principal path. While this approach to the assignment of an alternate path may be time intensive or require some measure of effort, the approach is consistent with the manner in which network operators may pre-plan traffic routes. Also, where a static or manual assignment of the alternate path is made, those skilled in this art will appreciate that such an assignment may occur infrequently as it need not necessarily be performed on a customer-by-customer basis but may be provisioned generally on the basis of differentiated services traffic type, regardless of customer identity. In other words, the alternate path assignments in question may be provisioned and shared for the entire class of customers of differentiated services traffic, as opposed to being provisioned individually and separately for each customer, each Virtual Private Network (“VPN”) or each Virtual Private Lan Service (“VPLS”).

The alternate path as aforesaid may, according to another embodiment of the method of the present invention, be assigned in conjunction with the assignment of the principal path. Namely, the alternate path may be assigned to the principal path as the latter is being assessed, selected or computed. In the selection of the principal path from a number of candidate paths which span the intended source location and the intended destination location, it was mentioned above that the cumulative transmission delay may be obtained by aggregating the transmission delays respectively associated with each of the principal path segments of a candidate path from the intended source location to the intended destination location. As mentioned previously, the principal path may be any candidate path which meets a specified maximum transmission delay constraint or alternatively, it may be the candidate path of the network 10 which meets the said constraint with the lowest associated end-to-end transmission delay. It was also mentioned above that further alternative constraints, such as path length or other path cost, may be added to the maximum delay constraint in the selection of the principal path. In a still further alternative embodiment, the selection of the principal path may additionally take into account whether every hop-by-hop segment in a candidate path is associated with a protected link as described above. Where every hop-by-hop segment of a candidate path is not associated with a protected link, candidate paths having one or more unprotected principal path segments may be ignored for purposes of principal path selection according to an embodiment of the method of the present invention.

To give an example of how a candidate path with unprotected principal path segments would be ignored for purposes of primary path selection in the context of the network 10, the candidate path ad-df-fh-hj would ordinarily be considered for the selection or assignment of a principal path for transmission of a differentiated services traffic flow between edge node A and edge node J. However, the principal path segment ad is not associated with a protected link as are the other principal path segments df, fh and hj of the candidate path ad-df-fh-hj, which are respectively associated with the protected link segments df′, fh′ and hj′. Accordingly, the candidate path ad-df-fh-hj would be ignored for purposes of principal path assignment under the still further alternative embodiment just discussed.

At ingress to the network 10, for instance at the ingress node A, differentiated services traffic may be forwarded via a principal path which has been assigned to the traffic and which is associated with an alternate path as defined above. On the other hand, non-differentiated services traffic such as best efforts or available forwarded traffic may be forwarded according to paths within the network 10 other than principal paths as aforesaid. Alternatively, the non-differentiated services traffic may be made to share either or both of the principal paths and alternate paths for the differentiated services traffic, with the differentiated services traffic receiving a higher forwarding priority than the non-differentiated services traffic. In essence, this establishes a survivable routing plane for differentiated services traffic and another routing plane for non-differentiated services traffic. Packets of a traffic flow may be marked or tagged for differentiated services forwarding by various mechanisms. For instance, DiffServ markings as known to those skilled in this art may be used for the purpose of indicating differentiated services forwarding. One example along these lines is the known Differentiated Service Code Point (“DSCP”) marking. Other examples for denoting a packet of a traffic flow as being subjected to differentiated services forwarding may be that of utilizing the known VPN-ID address according to Request for Comments 2685 dated September 1999 (“RFC 2685”) or that of utilizing the known VPN-IPv4 address scheme according to Request for Comments 2547 dated March 1999, each of the Internet Engineering Task Force, wherein either of these known addresses may be adapted to correspond in the present invention to the principal path which has been assigned to the traffic flow as previously discussed. Yet another alternative is to deploy one virtual router for the forwarding of differentiated services traffic and another virtual router for the forwarding of best efforts or other non-differentiated services traffic. Other means for marking, tagging, identifying or otherwise directing traffic for differentiated services forwarding will be apparent to those skilled in this art.

In operation, whenever differentiated services forwarding is required to be initiated for a given traffic flow, the initiation request in question may be provided to an appropriate edge router such as the node A of network 10. In such a case, the node A may include connection admission control (“CAC”) functionality or some other resource allocation capability. As well, the initiation request for differentiated services forwarding may instead be provided directly to a connection admission control entity or other resource allocation entity that may be separate or external from the node A and that provides the same functionality. Such requests may be made according to known protocols, for instance the Session Initiation Protocol (“SIP”), Next Steps in Signaling (“NSIS”) protocol, Resource Reservation Protocol (“RSVP”) or other available signaling techniques known to those skilled in this art. Alternatively, the initiation requests in question may be communicated externally of the network 10, for instance by means of an external network such as the Internet, or by means of a network management (“NM”) device. However the initiation request for differentiated services forwarding may be communicated, the connection admission control functionality will determine whether sufficient network resources are available to meet the bandwidth requirements of the differentiated services traffic by means of principal paths within the network 10. These principal paths will have already been created and assigned within the network 10 for the forwarding of such traffic. If the network resources are indeed available on at least one of the primary paths of the network 10, the connection admission control function will admit the request for differentiated services forwarding.

According to one embodiment of the present invention, the resource allocation capability such as the connection admission control functionality as aforesaid may be implemented on a per-flow reservation basis, where the connection admission control function will admit a request for differentiated services forwarding as and when such requests are being made. In another embodiment, the resource allocation may take place a priori or on a per-prefix basis by assigning a bandwidth weight to each ingress node, whereby the available bandwidth for every next hop segment from ingress to egress is computed as a proportionate share of the actual available bandwidth on each said segment, based upon a weighted distribution among all ingress nodes utilizing that segment. Under this a priori resource reservation scheme, only the smallest computed bandwidth share on any next hop segment from ingress to egress is retained for connection admission control purposes, and when an ingress node thereafter receives a request for differentiated services traffic forwarding, the flow in question will be admitted only if the bandwidth requirements of the flow meet the said smallest computed bandwidth share as aforesaid. Flow reservation from multiple ingress sources may therefore merge at a common intermediate node, towards a common destination prefix. Hence, in such cases the flow reservation need not be propagated all the way to the egress node. This scheme may therefore be expected to be more scalable than known RSVP techniques that perform per-flow reservation.

Wherever the connection admission control function is localized, whether within an ingress node such as the node A or externally by means of a separate entity, the connection admission control function will require current information on the available bandwidth of the primary paths and constituent primary path segments of the network 10 which are intended for the forwarding of differentiated services traffic. Such available bandwidth information may also include link state information in respect of whether or not a link along a primary path is or remains operational. The connection admission control function may therefore be updated as to the bandwidth availability of a principal path upon every new admission or release of differentiated services traffic utilizing such path. Moreover, periodic updating of bandwidth availability and link state information may be provided to the connection admission control function wherever same is located, for instance at each node of the network 10 which may initiate or admit a request for differentiated services traffic forwarding. Such periodic updating may employ existing topology state advertisement or resource allocation signaling mechanisms, for instance based upon the OSPF or OSPF-TE protocols known to those in this art. Rather than distributing bandwidth availability or link state information to all nodes in a network 10, persons skilled in the art will understand that unlike many existing topology state advertisement mechanisms, the information in question need only be distributed to nodes or other entities which perform connection admission control or other resource allocation functions for differentiated services traffic flows.

When compared to the prior art techniques of forwarding differentiated services traffic, the method of the present invention may be expected to offer some measure of scalability than known schemes involving circuit switching or path reservation. As well, when coupled with a call admission control function as discussed above, the method of the present invention can be expected to provide an end-to-end network traffic path which is deterministically compliant with a predetermined category of transmission service, to the extent that alternate paths are assigned to primary paths for restoration purposes as previously described and that a call admission control function is coupled to initiation requests for forwarding differentiated services traffic. As compared to known DiffServ techniques, a separate forwarding or admission entity such as a DiffServ PHB known to those in this art is not required at every node of the network 10, since differentiated services traffic according to the present invention may be admitted at ingress via a connection admission control or other like resource allocation function. Thus resource allocation need not be signaled on a hop-by-hop basis to the intended destination as with current techniques. Moreover, given that the method of the present invention does not mandate resource reservation on every hop of the network 10, the typical call setup latency associated with some prior art techniques should not manifest itself. The only such expected latency with the method of the present invention may involve that associated with call admission.

With respect to known circuit switching, MPLS or RSVP techniques, the present invention does not require full resource allocation signaling in the core of the network 10, since available bandwidth and link state information need only be advertised to nodes of network 10 that perform call admission control functions. As such, the method of the present invention can be expected to exhibit relatively fewer states in the core of network 10 than a differentiated services traffic solution based on the known circuit switching, MPLS or RSVP techniques. When compared to the technique of provisioning pipes or trunks between every edge node of a network backbone, the method of the present invention is not expected to be associated with the N² problem known to those in this art. Lastly, when contrasted with other known methods of forwarding differentiated services traffic, the number of alternate paths or alternate path segments for restoration purposes can be expected to be reduced, given that such protected paths or links need only be provisioned for network paths intended for differentiated services traffic.

Those skilled in this art will understand that various modifications of detail may be made to the present invention, all of which would come within its spirit and scope.

I claim:

1. A method of forwarding traffic in a connectionless communications network from a source location to a destination location, the traffic being associated with a predetermined category of transmission service, the method comprising the steps of:
assigning a principal path to the traffic, the principal path operatively connecting the source location with the destination location, the principal path being determined on the basis that transmission of the traffic from the source location to the destination location does not exceed a specified maximum delay for transmission; and
assigning an alternate path to the traffic, the alternate path being selected on the basis that the alternate path does not exceed a specified maximum delay for invoking the alternate path in order to forward the traffic therealong in the event that the principal path is unavailable therefor.

2. The method according to claim 1, wherein the principal path for the traffic is additionally determined on the basis of the shortest path from the source location to the destination location, wherein such shortest path does not exceed the specified maximum delay for transmission of the traffic as aforesaid.

3. The method according to claim 1, wherein the principal path for the traffic is additionally determined on the basis of the lowest cost path from the source location to the destination location, wherein such lowest cost path does not exceed the specified maximum delay for transmission of the traffic as aforesaid.

4. The method according to claim 2, wherein at least one intermediate node is located in the network between the source location and the destination location, with the source location, destination location and all intermediate nodes therebetween being operatively connected by node-to-node segments, and wherein the specified maximum delay for transmission of the traffic from the source location to the destination location is a cumulative maximum delay which is aggregated from transmission delays respectively associated with each of said node-to-node segments.

5. The method according to claim 4, wherein the shortest path is determined on the basis of being the path with the fewest number of said node-to-node segments between the source location and the destination location.

6. The method according to claim 5, wherein the alternate path for the traffic is selected from the group consisting of a physical link, a forwarding adjacency, a bypass tunnel, a label switched path and a protection path.

7. The method according to claim 1, wherein the assignment of the alternate path is made in conjunction with that of the principal path, in that a candidate traffic path of the network is ignored in the determination of the principal path if the candidate traffic path exceeds the specified maximum delay for invoking the alternate path as aforesaid.

8. The method according to claim 1, further comprising the step of:
after the steps of assigning the principal path and the alternate path to the traffic, admitting a traffic flow having the predetermined category of transmission service for forwarding along the principal path, wherein said step of admitting includes verifying that a sufficient network resource is available on the principal path for forwarding the traffic flow therealong.

9. The method according to claim 8, further comprising the step of:
maintaining an accounting of the network resource that is available on the principal path.

10. The method according to claim 9, wherein the step of maintaining an accounting of the network resource that is available on the principal path includes advertising availability of the network resource to a network entity which performs the step of admitting the traffic flow.

11. The method according to claim 10, wherein said advertising is accomplished by way of a topology state protocol.

12. The method according to claim 10, wherein the step of admitting the traffic flow is performed by an edge node of the network at the source location.

13. The method according to claim 10, wherein the step of admitting the traffic flow is performed by a network management entity.

14. The method according to claim 8, further comprising the step of:
after the step of admitting the traffic flow, identifying constituent packets of the traffic flow and directing said packets for forwarding along the principal path.

15. The method according to claim 14, wherein constituent elements of the traffic flow are marked with an identifier denoting said constituent elements as belonging to the traffic flow.

16. The method according to claim 15, wherein the network operates according to the Internet Protocol suite and the constituent elements of the traffic flow are Internet Protocol packets.
